(19) United States
(12) Patent Application Publication
(10) Pub. No.: US 2026/0085736 A1
(43) Pub. Date: Mar. 26, 2026

(54) ELECTROMECHANICAL BRAKE ASSEMBLY DRAG PREVENTION AND PAD WEAR DETECTION USING MOTOR POSITION

(71) Applicant: HL MANDO CORPORATION, Gyeonggi-do (KR)

(72) Inventor: Gyunghun SIM, Auburn, MI (US)

(21) Appl. No.: 19/230,969

(22) Filed: Jun. 6, 2025

Related U.S. Application Data
(60) Provisional application No. 63/697,443, filed on Sep. 20, 2024.

(51) Int. Cl. F16D 65/66; B60T 8/171; B60T 13/74; B60T 17/22; F16D 65/18; F16D 65/38; F16D 66/00; F16D 66/02; F16D 121/24; F16D 125/44

(52) U.S. Cl. CPC F16D 65/66; B60T 8/171; B60T 13/746; B60T 17/22; F16D 65/18; F16D 66/026; F16D 2065/386; F16D 2066/003; F16D 2066/005; F16D 2121/24; F16D 2125/44

(57) ABSTRACT

An electromechanical brake (EMB) system is provided. The EMB system may include: a brake rotor configured to be rotatable with a wheel of a vehicle; a brake pad assembly configured to be engageable with the brake rotor; an actuator assembly comprising an electric motor configured to mechanically move the brake pad assembly toward or away from the brake rotor via driving of a driven pulley; and an electronic control unit (ECU) coupled the actuator assembly, the ECU having a processor coupled to a memory that stores instructions that when executed by the processor causes the ECU to perform operations. The operations may include: using only a motor position of the electric motor and a clamp force exhibited when the brake pad assembly engages with the brake rotor to prevent occurrence of drag in the EMB assembly.

### CROSS REFERENCE TO PARENT APPLICATIONS

This application claims the benefit of U.S. Patent Application Ser. No. 63/697,443 filed on Sep. 20, 2024, entitled “HOME POSITION CONTROL AND PAD WEAR MONITOR STRATEGY OF ELECTRO-MECHANICAL BRAKE”, the entirety of which is incorporated herein by reference.

### BACKGROUND

Various embodiments of the present disclosure generally relate to an electromechanical brake (EMB) system (also referred to herein as an “EMB assembly”) and more particularly to an inductive position sensor of the EMB system.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” EMB systems, and electric or “brake by wire.”

For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, an electromechanical brake (EMB) assembly may comprise: a brake rotor configured to be rotatable with a wheel of a vehicle; a brake pad assembly configured to be engageable with the brake rotor; an actuator assembly comprising an electric motor configured to mechanically move the brake pad assembly toward or away from the brake rotor via driving of a driven pulley; and an electronic control unit (ECU) coupled the actuator assembly, the ECU comprising a processor coupled to a memory that stores instructions that when executed by the processor causes the ECU to perform operations comprising: using only a motor position of the electric motor and a clamp force exhibited when the brake pad assembly engages with the brake rotor to prevent occurrence of drag in the EMB assembly.

The using of only the motor position of the electric motor and the clamp force exhibited when the brake pad assembly engages with the brake rotor to prevent the occurrence of drag in the EMB assembly comprises, during a braking operation of the vehicle: obtaining a stored home position of the electric motor and a first motor position of the electric motor associated with the stored home position; determining, using the clamp force, a contact position of the electric motor and a second motor position of the electric motor at the contact position; obtain a safety clearance region using the first motor position and the second motor position; and causing the electric motor of the EMB assembly to stop rotating within the safety clearance region at an end of the braking operation.

The stored home position is obtained at a start of the braking operation from the memory of the ECU.

The contact position is determined based on the clamp force exhibited matching a predetermined clamp force value.

The electric motor stops rotating within the safety clearance region at a third motor position of the electric motor that corresponds to a distance that is equal or greater than a predetermined clearance value where the occurrence of drag in the EMB assembly is prevented.

The first motor position and the second motor position are measured using an inductive position sensor installed within the EMB assembly, the inductive position sensor being configured to measure a motor position of the electric motor.

The electric motor stops rotating within the safety clearance region at a third motor position of the electric motor, and the operations further comprise: updating the stored home position to an updated home position, the updated home position being associated with the third motor position of the electric motor.

The operations further comprise: using the updated home position, an original home position, and an original pad thickness of brake pads of the brake pad assembly to determine a pad wear rate of the brake pads.

The operations further comprise: determining whether the pad wear rate exceeds a pad wear rate threshold; and providing, in response to determination that the pad wear rate exceeds the pad wear rate threshold, a pad wear rate progress warning to a driver of the vehicle.

The EMB assembly is configured without any sensors for measuring a linear movement of the brake pad assembly and a linear movement of a translatable part that is actuated by the electric motor to mechanically move the brake pad assembly toward or away from the brake rotor.

According to various embodiments of the present disclosure, a motor vehicle may comprise: at least two road wheels; and at least one electromechanical braking (EMB) assembly attached to one of the at least two road wheels, wherein the at least one EMB assembly comprises an electronic control unit (ECU) that is configured to: using only a motor position of an electric motor of the EMB assembly and a clamp force exhibited when a brake pad assembly of the EMB assembly engages with a brake rotor of the EMB assembly to prevent occurrence of drag in the EMB assembly, wherein the brake rotor is configured to be rotatable with the one of the at least two road wheels, the brake pad assembly is configured to be engageable with the brake rotor, and the EMB assembly further comprises an actuator assembly comprising the electric motor where the ECU is coupled to the actuator assembly and the electric motor is configured to mechanically move the brake pad assembly toward or away from the brake rotor.

According to some embodiments of the present disclosure, a method configured to be executed by an electric control unit (ECU) associated with an electromechanical brake (EMB) assembly may comprise: using only a motor position of an electric motor of the EMB assembly and a clamp force exhibited when a brake pad assembly of the EMB assembly engages with a brake rotor of the EMB assembly to prevent occurrence of drag in the EMB assembly, wherein the brake rotor is configured to be rotatable with a wheel of a vehicle in which the EMB assembly is installed, the brake pad assembly is configured to be engageable with the brake rotor, and the EMB assembly further comprises an actuator assembly comprising the electric motor where ECU is coupled to the actuator assembly and the electric motor is configured to mechanically move the brake pad assembly toward or away from the brake rotor.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of a brake assembly according to one or more exemplary embodiments of the present disclosure.

FIGS. 2A and 2B show graphs for determining a home position according to one or more exemplary embodiments of the present disclosure.

FIGS. 3A-3C show graphs for determining pad wear using the home position according to one or more exemplary embodiments of the present disclosure.

FIG. 4 shows a flowchart according to one or more exemplary embodiments of the present disclosure.

FIG. 5 shows a schematic view of a vehicle including a steering system and a brake assembly according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

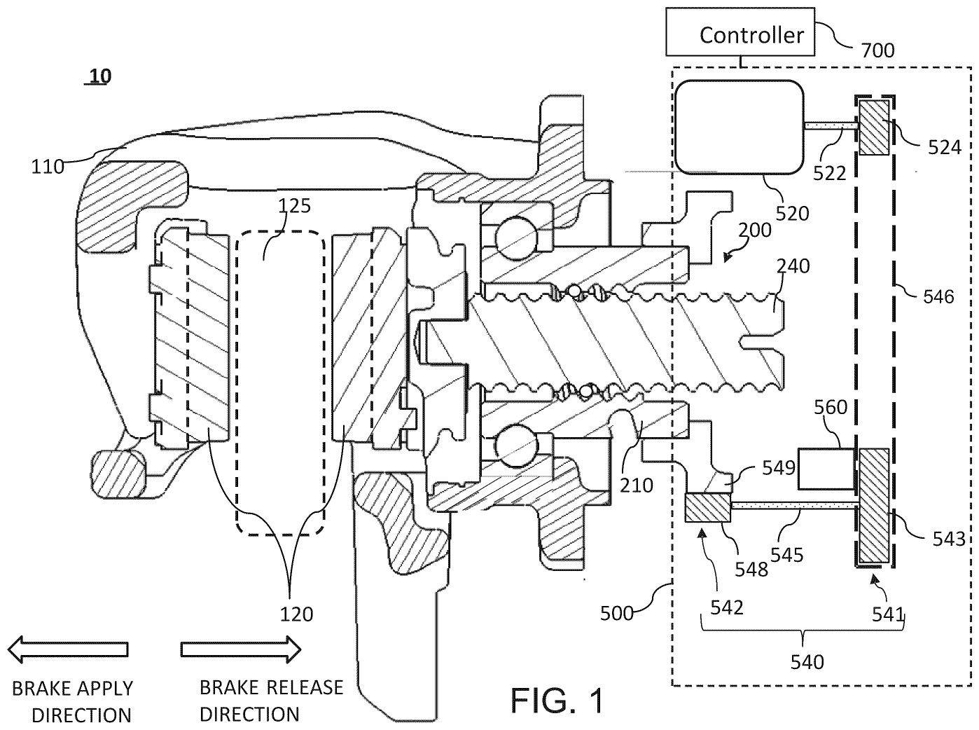

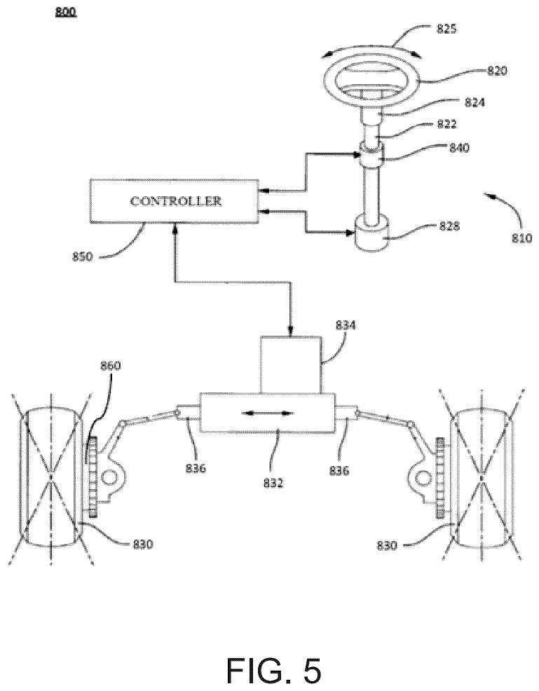

A vehicle (see, e.g., FIG. 5) may be equipped with one or more brake systems (e.g., an EMB system or the like) for slowing down or stopping rotation of a wheel of the vehicle (e.g., providing braking and stopping capabilities for vehicle). Such brake systems may be equipped with brake pads (e.g., 120, FIG. 1) that engage with a brake rotor (e.g., 125, FIG. 1) to stop movement of a road wheel (e.g., of a vehicle) when braking operations are applied by a driver (e.g., a human driver, a non-human driver, or the like) of the vehicle. Drag may occur when components of the brake systems, such as the brake pads, brake rotors, and/or a translatable part (e.g., 240, FIG. 1) that moves the brake pads, when these is not enough clearance (e.g., not big enough of an air gap or the like) between these components. Such clearance may usually be sensed (e.g., measured, obtained, or the like) using a linear sensor that is configured to measure the distances between these components. However, inclusion of such a linear sensor (or linear sensors) in a brake system may not be practical (e.g., from both a mechanical and financial standpoint) since brake systems are now required to be more compact and take up less space when installed. Additionally, the positions at which these linear sensors are installed usually expose these linear sensors to the elements and/or other non-ideal movements within the brake system, causing faster deterioration of these sensors and inaccurate readings. Thus, there has been a long felt need in the field of vehicle technology for brake systems that are able to reduce drag without the need and/or use of linear sensors.

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 (e.g., an electromechanical brake (EMB) system, or the like) is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatable part 210. Alternatively, the electric motor 520 is indirectly connected to the rotatable part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable part 210 of the drive mechanism 540. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the electric motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of a rotatable body or nut of rotatable part 210 of the drive mechanism 540 or screw mechanism 200 or be mounted to the rotatable body of rotatable part 210 of the drive mechanism 540 to rotate the rotatable body or nut of rotatable part 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assembly 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake is applied, the displacement of the brake pad assembly 120 in the brake release direction can cause the rotor of the electric motor 520 (e.g., the motor shaft 522) to rotate due to the mechanical connection between the electric motor 520 and the brake pad assembly 120. As a result, a position of the electric motor 520 can be used to determine a linear position of the brake pad assembly 120, and vice versa.

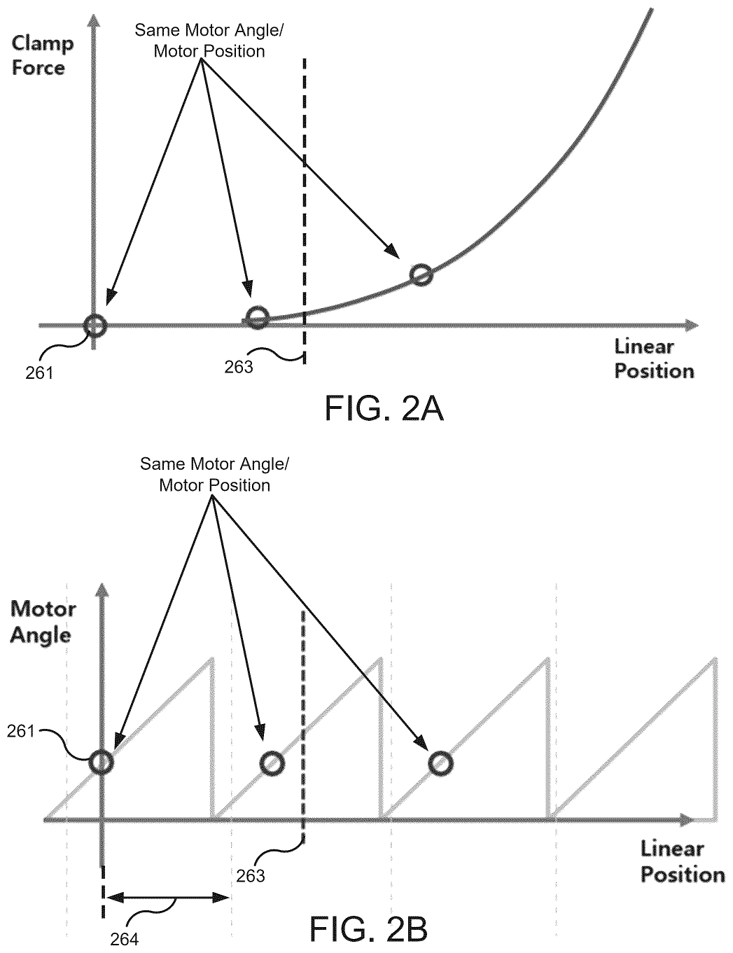

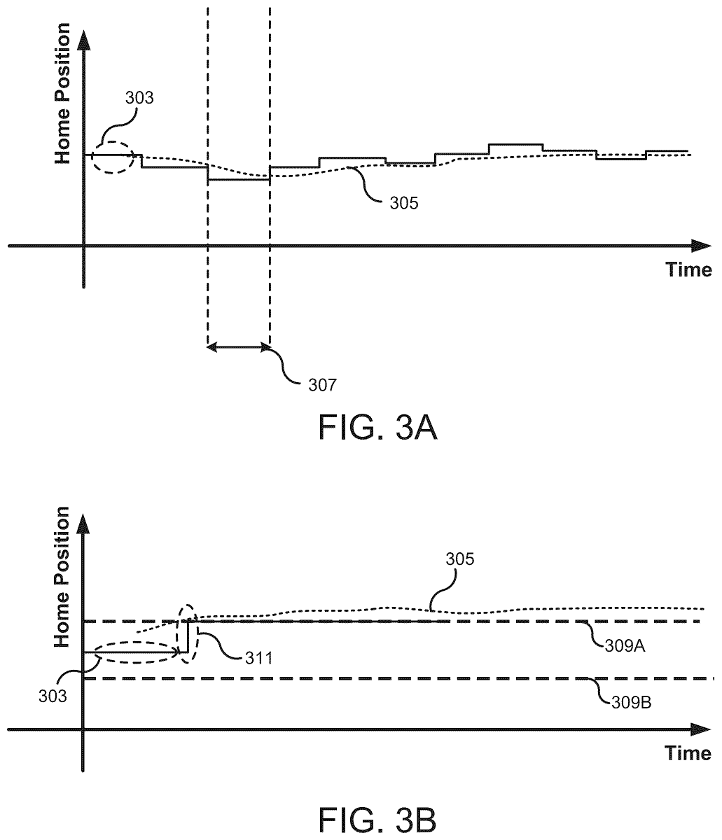

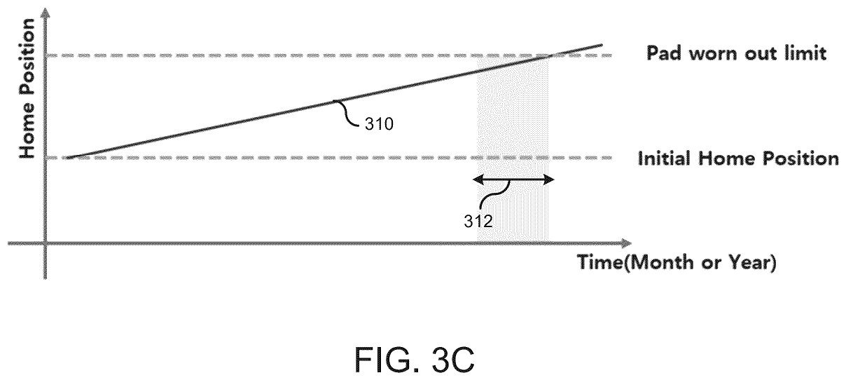

To detect such changes in the linear position of the brake pad assembly 120, brake assembly 10 may further include a controller 700 that is able to measure a movement and/or position of the electric motor 520 (e.g., via one or more sensors not shown in FIG. 1) and a torque (e.g., motor torque) generated by the electric motor 520. The controller 700 may also be configured to control the electric motor 520 to perform braking operations of the brake assembly 10 (e.g., the above discussed movement of the translatable part 240 to cause the brake pad assembly 120 to engage with the brake rotor 125). One example of the sensors configured to be installed within the brake assembly 10 may be the inductive position sensor of embodiments disclosed herein that is described in more detail in reference to FIGS. 2A-3B.

These one or more sensors may include any type and combination of sensors including, but not limited to: (i) force sensors, (ii) motor angle sensors; (iii) linear position sensors; (iv) temperature sensors; (v) current sensors; (iv) torque sensors; or the like. These one or more sensors may also be disposed (e.g., installed) within any portion of the brake assembly that is in proximity of the component or components that the sensors are configured to monitor and from which the sensors are configured to obtain measurements (e.g., obtain sensor readings from).

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components. The controller 700 may be coupled to (e.g., one or more components of) the actuator assembly.

FIGS. 2A and 2B show graphs for determining a home position in accordance with one or more exemplary embodiments of the present disclosure.

In embodiments, in a first example where the translatable part 240 and the brake pad assembly 120 are not connected to each other (e.g., an air gap can be created between the translatable part 240 and the brake pad of the brake pad assembly 120 closest to the translatable part 240), the home position may refer to the initial position of the translatable part 240 at the start of a braking operation (e.g., when the vehicle is starting to perform a braking operation).

More specifically, this initial position of the translatable part 240 may be set by a manufacturer of the brake assembly 10 based on a size of an air gap desired by the manufacturer between the translatable part 240 and the brake pad of the brake pad assembly 120 closest to the translatable part 240. This initial position (also referred to herein as an “original home position”) of the translatable part 240 may also be set during an initial installation and calibration of the brake assembly 10 onto a road wheel of the vehicle. Once this initial position is set, it may be stored in controller 700 (e.g., in memory such as an Electrically Erasable Programmable Read-Only Memory (EEPROM) or the like) as the original home position of the translatable part 240.

In embodiments, in a second example where the translatable part 240 and the brake pad assembly 120 are connected together (e.g., the translatable part 240 and brake pad of the brake pad assembly 120 closest to the translatable part 240 are in direct contact with one another), the home position may refer to the initial position of the brake pad that is connected to the translatable part 240 at the start of a braking operation (e.g., when the vehicle is starting to perform a braking operation).

More specifically, this initial position of the brake pad (e.g., the right-side brake pad of brake pad assembly 120 in FIG. 1) that is connected to the translatable part 240 may be set by a manufacturer of the brake assembly 10 based on a size of an air gap desired by the manufacturer between the brake pad and the brake rotor 125. This initial position (also referred to herein as an “original home position”) of the brake pad connected to the translatable part 240 may also be set during an initial installation and calibration of the brake assembly 10 onto a road wheel of the vehicle. Once this initial position is set, it may also be stored in controller 700 as the original home position of the brake pad connected to the translatable part 240.

Regardless of which configuration (e.g., the configurations of the first example and the second example of embodiments disclosed herein) is included in the brake assembly, the clearance (i.e., air gap) is necessary to prevent drag from occurring during non-braking operations of the vehicle (e.g., when the brake pedal and/or a braking operation is not applied by the driver). Such drag may be caused when, for example, but no limited to at least one brake pad of the brake pad assembly 120 still being in contact with the brake rotor 125 even after braking operations are not required. Such contact between the at least one brake pad of the brake pad assembly 120 and the brake rotor 125 may be caused when, for example, but not limited to the clearance (e.g., the air gap between the at least one brake pad and the brake rotor 125 or the air gap between the translatable part 240 and the brake pad assembly 120) being too small or non-existent.

In embodiments, instead of using a linear position sensor (which does not exist in brake assembly 10) to measure a position of the brake pad assembly 120 and/or the translatable part 240, the home position may be determined using a motor angle (e.g., a motor position, or the like) of the electric motor 520 and a clamp force generated during engagement between the brake pad assembly 120 and the brake rotor 125 during a braking operation of the vehicle. In embodiments, the home position 261 may be determined (e.g. re-determined by controller 700) after completion of each braking operation by the vehicle.

For example, when the brake assembly 10 is first installed and calibrated, the controller 700 may be pre-set (e.g., by a manufacturer of the brake assembly 10 and/or the vehicle) to move the translatable part 240 a predetermined distance away from the brake apply direction (i.e., to move backwards in the brake release direction of FIG. 1) until the original home position is reached. The motor position of electric motor 520 measured (e.g., using an inductive position sensor or the like) at when the original home position is reached may be recorded and saved with the original home position (e.g., as the motor position associated with the original home position).

The motor position of electric motor 520 at the original home position is shown as point 261 on the graphs shown in FIGS. 2A and 2B. As a braking operation is performed by the vehicle (e.g., in combination with brake assembly 10), the electric motor 520 is rotated to move (e.g., actuate) the translatable part 240 in the brake apply direction (see, e.g., FIG. 1). As the translatable part 240 is moved in the brake apply direction, the clamp force in the brake assembly 10 increases as the brake pads of the brake pad assembly 120 clamps onto the brake rotor 125 to stop rotation of the wheel. Such increase in the clamp force is also shown in graph of FIG. 2A.

In embodiments, the controller 700 may be configured with a set point and/or threshold values for determining when the brake pads of the brake pad assembly 120 have come into contact with the brake rotor 125 (e.g., also referred to as a “contact position” between the brake pads of the brake pad assembly 120 and the brake rotor 125). This set point and/or threshold values for this contact position may be a predetermined clamp force value and/or values. In the example of FIGS. 2A and 2B, the contact position is shown as point 263 on the respective graphs.

Between the original home position 261 and the contact position 263, the electric motor 520 may have made more than one complete rotation. In particular, as shown in FIGS. 2A and 2B, the contact position 263 happens after the electric motor 520 has made one and about one-tenth ( 1/10) or so of a rotation (i.e., the contact position 263 occurs slightly after the same motor angle as the original home position 261 motor angle has been detected/measured). More specifically, as shown in FIG. 2B, each triangle represents a full rotation of the electric motor 520.

Based on these data points shown in FIGS. 2A and 2B, the controller 700 would know that rotating the electric motor 520 approximately one and one-tenth in the opposite direction (e.g., after reaching the contact position 263 again when the brakes are released), would return the translatable part 240 (and/or the brake pad connected to the translatable part 240) to the original home position.

However, due to factors such as the frequent occurrence of the braking operation, pad wear of the brake pads of the brake pad assembly, mechanical deviations, sensor accuracy, or the like, it is impossible for the controller 700 to actuate the electric motor 520 with such precision and accuracy that the translatable part 240 (and/or the brake pad connected to the translatable part 240) would always return to the original home position after each braking operation.

Thus, a safety clearance region 264 may be established based on the data points of FIGS. 2A and 2B measured and observed by controller 700 during one or more braking operations. This safety clearance region 264 may start with the original home position 261 as a baseline (i.e., as a starting point of the safety clearance region 264) and a point before the contact position 263 as an ending point of the safety clearance region 264. This point before the contact position 263 may be predetermined by the manufacturer of the brake assembly 10 and/or the motor vehicle based on a desired clearance (i.e., air gap) between either the translatable part 240 and the brake pad assembly 120 (i.e., as in the first example of embodiments disclosed herein) or the brake pad connected to the translatable part 240 and the brake rotor 125 (i.e., as in the second example of embodiments disclosed herein).

For example, the ending point of the safety clearance region 264 may be based on a desired amount of clearance by the manufacturer between the components discussed in reference to the first and second examples of embodiments disclosed herein. Additionally, based on the specifications (e.g., size, shape, rating, etc.) of the components of the brake assembly 10, each motor angle (i.e., each one degree of rotation by electric motor 520) may be associated with a predetermined distance specified by the manufacturer. Said another way, each one degree of rotation of the electric motor 520 may be defined by the manufacturer as a 0.1 mm (or the like) movement of the translatable part 240 or the like. Thus, the rotation of the electric motor 520 between two given points of interest (e.g., between the original home position and the contact position 263) may be translated from the motor position (e.g., motor angle) to a movement distance of the translatable part 240 (or the like).

Thus, essentially, this safety clearance region 264 may be a region defined by the manufacturer (e.g., using the original home position 261 as a starting point) where the manufacturer believes that the translatable part 240 and/or the brake pad connected to the translatable part 240 will return to a position where there is still sufficient clearance that drag can be avoided and/or prevented after a braking operation has ended.

For example, if the travel distance of the translatable part 240 (or the like) between the original home position 261 and the contact position 263 is 1 cm and the desired clearance is at least 20 mm, then the ending point of the safety clearance region 264 would be at least 20 mm (as translated to motor rotation/motor position of electric motor 520) away from the contact position 263.

Other methods for determining and/or setting the safety clearance region 264 may also be used without departing from the scope of embodiments disclosed herein. For example, if each degree of rotation by the electric motor moves the translatable part 240 at least 1 mm, then the end of the safety clearance region 264 may be 20 degrees in rotation away from the motor angle/motor position measured (i.e., detected, observed, or the like) at the contact position 263. Even further, instead of setting the safety clearance region 264, the electric motor 520 may simply be configured to be rotated back half of the total rotation associated with the original home position 261 and the contact position 263 (i.e., if the electric motor 520 rotated 1 and a half full turns (i.e., 540 degrees) between the original home position 261 to the contact position 263, then the electric motor 520 can be rotated backwards 270 degrees).

As shown in FIG. 2B, the safety clearance region 264 starts at original home position 261 and ends right before the electric motor 520 makes one full rotation and sufficiently before the contact position 263.

As a result, in embodiments, rather than requiring the controller 700 to accurately and precisely control the electric motor 520 to return to the motor position associated with the original home position after each braking operation, the controller 700 only has to return the electric motor 520 to a motor position within the safety clearance region 264. Thus, the brake assembly 10 can advantageously prevent and/or avoid occurrence of drag after each braking operation without needing a linear sensor be installed within the brake assembly 10 to measure the linear movement of the translatable part 240 and/or the brake pad connected to translatable part 240 (e.g., to measure and/or sense that the correct clearance (i.e., airgap) needed for avoiding/preventing drag is being maintained).

Turning now to FIGS. 3A-3B, FIGS. 3A-3C show graphs for determining pad wear using the home position according to one or more exemplary embodiments of the present disclosure.

Starting with FIG. 3A, FIG. 3A shows a graph for tracking changes in the original home position over time. In particular, the graph starts with tracking the original home position 303. The original home position 303 may then be updated to an updated home position after each braking operation 307.

An average home position 305 of the home positions (e.g., original and updated) is also shown in FIG. 3A. This average home position 305 may vary as a thickness of the brake pads of the brake pad assembly 120 changes due to environmental factors such as temperature, friction, or the like.

Turning now to FIG. 3B, the controller 700 may be preset with two threshold limits including an upper home position update threshold 309A and a lower home position update threshold 309B for determining when the original home position should be updated to the updated home position. In particular, when electric motor 520 stops at a motor position that does not correspond to the motor position associated with the original home position 303 (i.e., the electric motor 520 is caused to stop within safety clearance region 264), the difference between the motor position associated with the original home position 303 and this new motor position is calculated.

In embodiments, if this difference exceeds either the upper home position update threshold 309A or the lower home position update threshold 309B, the original home position will be updated to the updated home position. Said another way, the new motor position will now be used as a reference point for determining the home position (i.e., the updated home position will now be used instead of the original home position).

When the home position is updated from the original home position to the updated home position, certain data the points on the graphs of FIGS. 2A and 2B may also change. For example, the controller 700 may now need to update (e.g., re-determine) the safety clearance region 264 (or the like) based on the change from the original home position to the updated home position. The same principle of using the motor position detected at the updated home position, the motor position detected at the contact position 263, and at least the manufacturer's predetermined clearance requirement as discussed above in reference to FIGS. 2A and 2B may be used for updating the data points on the graphs of FIGS. 2A and 2B.

Although determination of the original home position 261, contact position 263, safety clearance region 264, and the like are shown using graph form in FIGS. 2A and 2B, the controller 700 may not actually generate and/or plot any graphs and may determine (e.g., calculate, estimate, or the like) these values and/or data points without the need of any of the graphs.

FIG. 3C shows a graph for using the updated home position to determine whether the brake pads of the brake pad assembly 120 have been worn out to the point of needing to be replaced. In particular, the updated home position 310 is plotted against a change in time in FIG. 3C. When a difference between the updated home position 310 and the original home position exceeds a predetermined pad worn out limit threshold (i.e., the pad worn out limit line shown in FIG. 3C), the brake pads of the brake pad assembly 120 may need to be immediately replaced for safety concerns.

A warning period 312 may also be established based on the predetermined pad worn out limit threshold. When controller 700 detects that the difference between the updated home position and the initial home position as reached this warning period 312, the controller 700 may send a notification to a central controller (i.e., a chassis controller of the like) of the vehicle (that is separate from and operates independently from the controller 700) to notify the driver of the vehicle with a warning or the like to replace the brake pads of the brake pad assembly.

In embodiments, both the predetermined pad worn out limit threshold and the warning period 312 based on the predetermined pad worn out limit threshold may be preset and/or preconfigured into controller 700 by the manufacturer of the brake assembly 10 and/or the vehicle.

In embodiments, the controller 700 may also calculate a pad wear rate of the brake pads of the brake pad assembly 120 using, for example, the following equation:

$$Pad Wear Rate = \frac{\vert Original Home Position - Updated Home Position \vert}{Pad Thickness} \times 100 \%$$

where the pad thickness is the original pad thickness of the brake pads (when the brake pads are in a brand new condition) as specified by a manufacturer of the brake pads and/or the brake assembly 10.

In embodiments, if the controller 700 determines that the pad wear rate exceeds a predetermined pad wear rate limit value, the controller 700 may also send a warning to the driver regarding the pad wear rate progress of the brake pads of the brake pad assembly 120. The predetermined pad wear rate limit value may be prestored and/or preset in the controller 700 by the manufacturer of the brake assembly 10 and/or the vehicle.

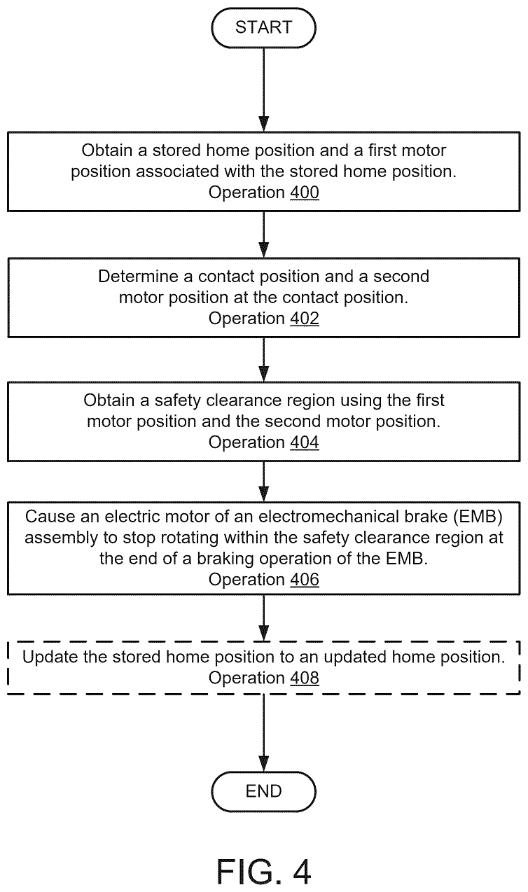

Turning to FIG. 4, a flowchart illustrating a method for controlling braking operations of the brake assembly 10 according to one or more exemplary embodiments of the present disclosure. The operations of the flowchart of FIG. 4 may be performed, for example, by the controller 700 of the brake assembly 10. The brake assembly 10 may be configured without any linear and/or distance sensors for measuring a linear movement of translatable part 240 and/or brake pads of the brake pad assembly 120. Although shown as a series of temporal steps, the operations of the flowchart 3 need not be performed in the exact order shown in FIG. 4 and any of the operations can be performed in any order without departing from the scope and spirit of embodiments disclosed herein. Steps shown using the broken lines may be optional.

At Operation 400, and as discussed above in reference to FIGS. 2A-3B, a stored home position (e.g., 261) may be obtained. In embodiments, the stored home position may be obtained at a start of a braking operation by the brake assembly 10. The stored home position may be associated with a first motor position of an electric motor 520 of the brake assembly 10.

In embodiments, the stored home position may be the original home position. In embodiments, the stored home position may be an updated original home position has been previously updated based on a result of a previous braking operation.

At Operation 402, and as discussed above in reference to FIGS. 2A-2B, a contact position (e.g., 263) and a second motor position of electric motor 520 may be determined (e.g., during execution of the braking operation).

In embodiments, the contact position may be determined when the controller 700 determines (e.g., sensors, measures, calculates, or the like) that a predetermined amount of clamp force has been exhibited as a result of the brake pad assembly 120 clamping onto the brake rotor 125 during the braking operation.

At Operation 404, and as discussed above in reference to FIGS. 2A-2B, a safety clearance region (e.g., 264) may be obtained using the first motor position and the second motor position.

In embodiments, a desired clearance (i.e., airgap) size may also be used, in addition to the first motor position and the second motor position to determine the safety clearance region.

At Operation 406, and as discussed above in reference to FIGS. 2A-2B, the electric motor 520 of the brake assembly 10 (e.g., an EMB assembly or the like) may be caused to stop rotating within the safety clearance region at the end of the braking operation of the EMB.

Thus, the brake assembly 10 can advantageously prevent and/or avoid occurrence of drag after each braking operation without needing a linear and/or distance sensor be installed within the brake assembly 10 to measure the linear movement of the translatable part 240 and/or the brake pad connected to translatable part 240 (e.g., to measure and/or sense that the correct clearance (i.e., airgap) needed for avoiding/preventing drag is being maintained).

In embodiments, the process of FIG. 4 may end following Operation 406.

At Operation 408, and as discussed above in reference to FIGS. 3A-3C, the stored home position may be updated to an updated home position.

In embodiments, the stored home position may be updated if the difference between the stored home position and the position at which the electric motor 520 stopped rotating at operation 406 exceeds either an upper home position update threshold (e.g., 309A) or a lower home position update threshold (e.g., 309B).

Such updates in the home position may also be used (e.g., as discussed above in reference to FIGS. 3A-3C) to determine a pad wear and a pad wear rate of the brake pads of the brake pad assembly 120.

In embodiments, the process of FIG. 4 may end following optional Operation 408.

Any vehicle according to certain exemplary embodiments of the present disclosure may be identical, or substantially similar to, vehicle 800 shown in FIG. 5. The vehicle 800 may be any passenger or commercial automobile such as a hybrid vehicle, an electric vehicle, or any other type vehicles. FIG. 5 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 820 from the road wheels 830. Accordingly, the steer-by wire steering system may comprise a feedback actuator or steering feel actuator 828 comprising an electric motor which is connected to the steering shaft or steering shaft 822. The feedback actuator or steering feel actuator 828 provides the driver or operator with the same “road feel” that the driver receives with a direct mechanical link.

Although the embodiment illustrated in FIG. 5 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical brake (EMB) assembly comprising:
a brake rotor configured to be rotatable with a wheel of a vehicle;
a brake pad assembly configured to be engageable with the brake rotor;
an actuator assembly comprising an electric motor configured to mechanically move the brake pad assembly toward or away from the brake rotor via driving of a driven pulley; and
an electronic control unit (ECU) coupled the actuator assembly, the ECU comprising a processor coupled to a memory that stores instructions that when executed by the processor causes the ECU to perform operations comprising:
using only a motor position of the electric motor and a clamp force exhibited when the brake pad assembly engages with the brake rotor to prevent occurrence of drag in the EMB assembly.

2. The EMB assembly of claim 1, wherein the using of only the motor position of the electric motor and the clamp force exhibited when the brake pad assembly engages with the brake rotor to prevent the occurrence of drag in the EMB assembly comprises, during a braking operation of the vehicle:
obtaining a stored home position of the electric motor and a first motor position of the electric motor associated with the stored home position;
determining, using the clamp force, a contact position of the electric motor and a second motor position of the electric motor at the contact position;
obtain a safety clearance region using the first motor position and the second motor position; and
causing the electric motor of the EMB assembly to stop rotating within the safety clearance region at an end of the braking operation.

3. The EMB assembly of claim 2, wherein the stored home position is obtained at a start of the braking operation from the memory of the ECU.

4. The EMB assembly of claim 2, wherein the contact position is determined based on the clamp force exhibited matching a predetermined clamp force value.

5. The EMB assembly of claim 4, wherein the electric motor stops rotating within the safety clearance region at a third motor position of the electric motor that corresponds to a distance that is equal or greater than a predetermined clearance value where the occurrence of drag in the EMB assembly is prevented.

6. The EMB assembly of claim 2, wherein the first motor position and the second motor position are measured using an inductive position sensor installed within the EMB assembly, the inductive position sensor being configured to measure a motor position of the electric motor.

7. The EMB assembly of claim 2, wherein
the electric motor stops rotating within the safety clearance region at a third motor position of the electric motor, and
the operations further comprise:
updating the stored home position to an updated home position, the updated home position being associated with the third motor position of the electric motor.

8. The EMB assembly of claim 7, wherein the operations further comprise:
using the updated home position, an original home position, and an original pad thickness of brake pads of the brake pad assembly to determine a pad wear rate of the brake pads.

9. The EMB assembly of claim 8, wherein the operations further comprise:
determining whether the pad wear rate exceeds a pad wear rate threshold; and
providing, in response to determination that the pad wear rate exceeds the pad wear rate threshold, a pad wear rate progress warning to a driver of the vehicle.

10. The EMB assembly of claim 1, wherein the EMB assembly is configured without any sensors for measuring a linear movement of the brake pad assembly and a linear movement of a translatable part that is actuated by the electric motor to mechanically move the brake pad assembly toward or away from the brake rotor.

11. A vehicle comprising:
at least two road wheels; and
at least one electromechanical braking (EMB) assembly attached to one of the at least two road wheels, wherein the at least one EMB assembly comprises an electronic control unit (ECU) that is configured to:
using only a motor position of an electric motor of the EMB assembly and a clamp force exhibited when a brake pad assembly of the EMB assembly engages with a brake rotor of the EMB assembly to prevent occurrence of drag in the EMB assembly,
wherein the brake rotor is configured to be rotatable with the one of the at least two road wheels, the brake pad assembly is configured to be engageable with the brake rotor, and the EMB assembly further comprises an actuator assembly comprising the electric motor where the ECU is coupled to the actuator assembly and the electric motor is configured to mechanically move the brake pad assembly toward or away from the brake rotor.

12. The vehicle of claim 11, wherein the ECU is configured to, during a braking operation of the vehicle:
obtain a stored home position of the electric motor and a first motor position of the electric motor associated with the stored home position;
determine, using the clamp force, a contact position of the electric motor and a second motor position of the electric motor at the contact position;
obtain a safety clearance region using the first motor position and the second motor position; and
cause the electric motor of the EMB assembly to stop rotating within the safety clearance region at an end of the braking operation.

13. The vehicle of claim 12, wherein the stored home position is obtained at a start of the braking operation from a memory of the ECU.

14. The vehicle of claim 12, wherein the contact position is determined based on the clamp force exhibited matching a predetermined clamp force value.

15. The vehicle of claim 14, wherein the electric motor stops rotating within the safety clearance region at a third motor position of the electric motor that corresponds to a distance that is equal or greater than a predetermined clearance value where the occurrence of drag in the EMB assembly is prevented.

16. A method configured to be executed by an electric control unit (ECU) associated with an electromechanical brake (EMB) assembly, the method comprising:
using only a motor position of an electric motor of the EMB assembly and a clamp force exhibited when a brake pad assembly of the EMB assembly engages with a brake rotor of the EMB assembly to prevent occurrence of drag in the EMB assembly,
wherein the brake rotor is configured to be rotatable with a wheel of a vehicle in which the EMB assembly is installed, the brake pad assembly is configured to be engageable with the brake rotor, and the EMB assembly further comprises an actuator assembly comprising the electric motor where ECU is coupled to the actuator assembly and the electric motor is configured to mechanically move the brake pad assembly toward or away from the brake rotor.

17. The method of claim 16, wherein the using of only the motor position of the electric motor and the clamp force exhibited when the brake pad assembly engages with the brake rotor to prevent the occurrence of drag in the EMB assembly comprises, during a braking operation of the vehicle:
obtaining a stored home position of the electric motor and a first motor position of the electric motor associated with the stored home position;
determining, using the clamp force, a contact position of the electric motor and a second motor position of the electric motor at the contact position;
obtain a safety clearance region using the first motor position and the second motor position; and
causing the electric motor of the EMB assembly to stop rotating within the safety clearance region at an end of the braking operation.

18. The method of claim 17, wherein the stored home position is obtained at a start of the braking operation from a memory of the ECU.

19. The method of claim 17, wherein the contact position is determined based on the clamp force exhibited matching a predetermined clamp force value.

20. The method of claim 19, wherein the electric motor stops rotating within the safety clearance region at a third motor position of the electric motor that corresponds to a distance that is equal or greater than a predetermined clearance value where the occurrence of drag in the EMB assembly is prevented.
